(19) United States
(12) Patent Application Publication
(10) Pub. No.: US 2012/0142089 A1
(43) Pub. Date: Jun. 7, 2012

(54) METHOD OF SEPARATING TARGET CELL IN BIOLOGICAL SAMPLE

(75) Inventor: Jong-myeon PARK, Yongin-si (KR)

(73) Assignee: SAMSUNG ELECTRONICS CO., LTD., Suwon-si (KR)

(21) Appl. No.: 13/302,678

(22) Filed: Nov. 22, 2011

(30) Foreign Application Priority Data
Dec. 1, 2010 (KR) 10-2010-0121333
Oct. 28, 2011 (KR) 10-2011-0111416

(51) Int. Cl. C12N 5/09; C12N 5/0735; C12N 5/078; C12N 5/071

(52) U.S. Cl. 435/325

(57) ABSTRACT

Provided is a method of separating a target cell in a biological sample. A target cell may be efficiently separated from a biological sample including at least a second cell of similar density to the target cell using the disclosed method of separating a target cell in a biological sample according embodiment.

### CROSS-REFERENCE TO RELATED APPLICATIONS

This application claims the benefit of Korean Patent Application No. 10-2010-0121333, filed on Dec. 1, 2010, and Patent Application No. 10-2011-0111416, filed on Oct. 28, 2011, in the Korean Intellectual Property Office, the disclosure of which is incorporated herein in its entirety by reference.

### BACKGROUND

1. Field

The present disclosure relates to methods of separating a target cell in a biological sample.

2. Description of the Related Art

The majority of deaths associated with malignant tumors are due to the metastasis of primary tumor cells to tissues and organs distant from the initial tumor. Accordingly, early diagnosis of metastasis is a critical factor for the survival of a cancer patient, and early diagnosis of a tumor and monitoring of tumor growth are considered to be very important factors for successful treatment of a cancer patient. Cancer diagnosis usually involves diagnosis techniques related to histopathology. A histopathological diagnosis technique is a method of using a tissue sample from a living subject to diagnose cancer. Such a histopathological approach allows a tumor cell to be directly observed. However, the histopathological approach may be inaccurate in determining whether there is a tumor, since the sample tissue site selected is obtained from a living subject, and only data about the particular site obtained from the living subject is obtained. Thus it can be difficult to know whether a tumor has metastasized to another site. For this reason, the applicability of the histopathological diagnosis technique in diagnosing and monitoring tumors may be limited.

Circulating tumor cells (CTCs) may be found in a patient before a tumor is initially detected. Accordingly, CTCs may play an important role in early diagnosis and prognosis of cancers. In addition, because cancer usually metastasizes through the blood, a CTC may be a marker for determining whether cancer has metastasized. Even after cancer cells have been removed by surgery, CTCs may still be found. In this case, this may indicate that cancer may reoccur. However, very small numbers of these CTCs are found in blood and the cells are themselves weak. It is thus very difficult to detect them and determine the number of the cells. Accordingly, there still remains a need for a diagnosis method that is highly sensitive with respect to detection of CTCs, cancer cells, or cancer stem cells in a patient's body.

The related art discloses a method of separating red blood cells, white blood cells, circulating cancer cells, and serum to manually separate a desired layer from them and use it. However, white blood cells and circulating cancer cells are not individually separated and exist as a mixture when the technology is used, and thus the method is disadvantageous in that the separation efficiency of white blood cells and circulating cancer cells is theoretically limited.

Other related art disclose cell margination and multi-orifice separation based on the principles of fluid dynamics. The former is a technology whereby the number of small cells such as red blood cells is relatively reduced and the number of the other cells is increased by using a phenomenon which occurs in actual blood vessels in which small particles gather in the inner part of the blood vessels and large particles move outside. The latter is a principle whereby a channel along which fluid flows has an expanded tube section to gather large particles and small particles outside and in the middle of the channel, respectively, according to Reynolds number. However, it is difficult to selectively separate a desired target cell from actual blood by using this principle, and there is limitation in treating a volume of several ml because the fluid flow rate is slow. However, it is necessary to dilute a fluid by several hundred times in order to control the Reynolds number, and thus there is a limitation in that samples of several hundred ml should be actually treated.

Accordingly, although the related art may be used, there still remains a need for a method of efficiently separating a target cell in a biological sample.

### SUMMARY

Provided are methods of separating a target cell in a biological sample.

In an embodiment, the method includes contacting a biological sample comprising a target cell and a second cell with a particle to which is bound a ligand specific to a surface marker of the target cell; allowing the ligand bound to the particle to specifically bind to the surface marker of the target cell to form a particle-target cell complex, wherein the particle-target cell complex has a density difference with the second cell; and separating the second cell from the particle-target cell complex by density gradient centrifugation.

Additional aspects will be set forth in part in the description which follows and, in part, will be apparent from the description, or may be learned by practice of the presented embodiments.

### BRIEF DESCRIPTION OF THE DRAWINGS

These and/or other aspects will become apparent and more readily appreciated from the following description of the embodiments, taken in conjunction with the accompanying drawings of which:

FIG. 1 illustrates results of flow cytometric analysis of Human EpCAM/TROP1 Fluorescein MAb (anti-EPCAM MAb) according to an exemplary embodiment;

FIG. 2 is a set of images showing the results of agglutination reactions between a particle with bound anti-EPCAM MAb and a breast cancer cell line, the images of panels (A) and (B) show results of control agglutination reactions between a particle without the bound anti-EPCAM MAb and the breast cancer cell line; and

FIG. 3 is a photograph illustrating results of separation of cancer cells in blood by density gradient centrifugation according to an exemplary embodiment.

FIG. 4 is a photograph illustrating results of separation of cancer cells in blood by centrifugation and filtration according to an exemplary embodiment.

### DETAILED DESCRIPTION

Methods of separating a target cell in a biological sample are disclosed herein.

According to an aspect of the present invention, a method of separating a target cell in a biological sample includes contacting a particle to which is bound at least one ligand specific to a surface marker of a target cell with a biological sample including at least one of the target cell and a second type of cell; allowing the at least one ligand bound to the particle to specifically bind to the surface marker of the target cell to form a particle-target cell complex, wherein the particle-target cell complex has a density different from that of the second cell; and separating the second cell from the particle-target cell complex by density gradient centrifugation. In an embodiment, the second type of cell has a density similar to that of the target cell.

The method of separating a target cell in a biological sample will be described in detail for each step thereof.

First, the method may include contacting a particle to which is bound at least one ligand specific to a surface marker of a target cell i with a biological sample including the target cell and a second cell. The second cell has a density different from that of the particle-target cell complex.

According to an exemplary embodiment, the density difference between the particle target cell complex and the second cell may have a range of about 0.005 g/cm³ to about 0.3 g/cm³, about 0.005 g/cm³ to about 0.1 g/cm³, or about 0.005 g/cm³ to about 0.05 g/cm³.

According to an exemplary embodiment, the particle may have a surface to which is bound at least one ligand specific to a surface marker of a target cell. The surface marker may be selected from the group consisting of protein, sugar, lipid, nucleic acid, and any combinations thereof. According to an exemplary embodiment, the surface marker may be a protein specifically expressed in a cancer or tumor cell to be shown in the cell membrane, i.e., an antigen, and, for example, estrogen receptor, progesterone receptor, synaptophysin, mucin 1 (MUC 1), Bcl-2, MIB1/Ki67, cyclin D1, cyclin E, p27, topoisomerase IIa, cyclooxygenase 2, ERK1/ERK2, phosphor-S6 ribosomal protein, CK5, CK8, CK17, vimentin, epithelial cell adhesion molecule (EpCAM), c-Met, cytokeratines, Her2, EGFR, p53, p63, E-cadherin, fragile histidine triad, protein tyrosine phosphatase, β-catenin, p16, c-kit, endothelin-1, endothelin receptor-α, endothelin receptor-β, chemokine (CXC motif) receptor 4, breast cancer resistance protein, ABCA3, MGMT, or any combinations thereof. In addition, the at least one ligand specific to the surface marker may be an antibody which may bind specifically to the antigen protein.

The ligand is bound to the surface of the particle. For example, when the ligand is an antibody, the constant region of the antibody may be bound to the surface of the particle such that the antigen-binding site may be exposed to the outside. Accordingly, because the ligand bound to the particle binds specifically to a surface marker of the target cell, the particle may be bound specifically to the target cell, via the ligand-surface marker interaction, to permit separation of the particle-target cell complex from the second cell.

According to an exemplary embodiment, the target cell may be selected from the group consisting of a circulating tumor cell, a cancer stem cell, an immunocyte, a fetal stem cell, a fetal cell, a cancer cell, and a tumor cell. The target cell may be, for example, a cancer cell or a tumor cell. The cancer cell or tumor cell may be a cell from a cancer selected from the group consisting of bladder cancer, breast cancer, cervical cancer, cholangiocarcinoma cancer, colorectal cancer, endometrial cancer, esophageal cancer, gastric cancer, head and neck cancer, kidney cancer, liver cancer, lung cancer, nasopharyngeal cancer, ovarian cancer, pancreatic cancer, gallbladder cancer, prostate cancer, thyroid cancer, osteosarcoma, synovial sarcoma, rhabdomyosarcoma, synovial sarcoma, Kaposi's sarcoma, leiomyosarcoma, malignant fibrous histocytoma, fibrosarcoma, adult T-cell leukemia, lymphoma, multiple myeloma, glioblastoma/astrocytoma, melanoma, mesothelioma, and Wilms' tumor.

According to an exemplary embodiment, the particle may alter the density of a target cell by binding to the target cell via the ligand specific to the surface marker of the target cell to form a particle-target cell complex. Thus, the particle may have a density value which may cause a difference in density between the particle-target cell complex in the biological sample and the second cell. For example, when the biological sample is blood in which a cancer cell is the target cell, the densities of white blood cells and red blood cells are known in the art, about 1.07 g/cm³ and about 1.1 g/cm³, respectively. Therefore, the kind of particle may be selected to have a density such that the density of the particle-target cell complex will permit the target cell, in the form of the particle-target cell complex, to separate from the white blood cells and the red blood cells in density gradient centrifugation. The particle may be made of any suitable polymer. The particle according to an exemplary embodiment may be selected from the group consisting of a polystyrene particle, a polymethylmethacrylate particle, a latex particle, an ABS (tert-polymer of acrylonitrile, butadiene, and styrene) particle, a cyclic olefin copolymer particle, melamine particle, magnetic particle and a complex thereof, but the particle is not limited to particles of these specific polymers. However, liposomal particles are excluded as particles in the method disclosed herein.

According to an exemplary embodiment, the diameter of the particle may be variously selected according to the kind of target cell to be separated. and the type of particle to be used. The diameter may be, for example, about 1 nm to about 100 μm, or about 10 nm to about 10 μm.

According to an exemplary embodiment, the density of the particle may be selected from various ranges depending on the target cell and the biological sample. For example, when a circulating cancer cell is the target cell to be separated in blood, the density of the particle may be greater than or equal to about 1.0 g/cm³ and less than or equal to about 2.0 g/cm³, or greater than or equal to about 1.3 g/cm³ and less than or equal to about 1.7 g/cm³, or greater than or equal to about 1.4 g/cm³ and less than or equal to about 1.6 g/cm³.

According to an exemplary embodiment, the biological sample may be any biological sample in which the target cell may be present. For example, the sample may be selected from the group consisting of a biopsy sample, a tissue sample, a cell suspension including a separated cell suspended in a liquid medium, a cell culture, and any combinations thereof. The sample may be selected from the group consisting of blood, marrow fluid, saliva, lacrimal fluid, urine, semen, mucous fluid, and any combinations thereof. For example, in order to separate CTCs, blood may be used as the biological sample.

According to an exemplary embodiment, the biological sample may include a target cell and a second cell. The second cell can have a density difference of, for example, about 0.005 g/cm³ to about 0.05 g/cm³ with the target cell. That is, the target cell may be specifically separated from among the two or more kinds of cells in the biological sample, all having a similar or identical density, by the method of separating a target cell according to an exemplary embodiment disclosed herein. Accordingly, when the density difference between the different cells in a biological sample is so small when density gradient centrifugation of the sample does not result in separate layers for each type of cell, the separation method disclosed herein may be used. For example, a hemocyte such as a white blood cell or a red blood cell is present in a blood sample including circulating tumor cells (CTCs), and the density of circulating tumor cells is similar to that of white blood cells in the blood sample and thus the circulating tumor cells may not be separated from the white blood cells by density gradient centrifugation. Accordingly, the apparent density of the circulating tumor cells may be altered by using the above-mentioned method to form a particle-CTC complex, and thus the circulating tumor cells may be separated as particle-CTC complexes from other hemocyte cells by density gradient centrifugation.

The contacting may be performed by adding a particle with the bound ligand specific to a surface marker of the target cell to a solution including the biological sample.

According to an exemplary embodiment, the method may further include, before the contacting, pre-treating the biological sample. For example, the pre-treatment may be performed to reduce the amount or remove materials other than cells from the sample. The pre-treatment may be selected from the group consisting of centrifugation, filtration, chromatography such as affinity chromatography, and any combinations thereof. For example, when the biological sample is blood, plasma may be removed from the blood sample in a pre-treatment step so that only proteins and cells remain in the sample. The proteins may be also removed from the blood sample, so that only the cells in the blood remain in the sample that may be used in the method disclosed herein. The cells remaining in the sample include cells other than the target cell originally present in the biological sample.

According to an exemplary embodiment, the particle may be coated with a compound having a charge on the surface in order to permit binding to the ligand specific to the surface marker of the target cell. The compound having the charge may be a compound having a functional group selected from the group consisting of an amine group, an imine group, and any combinations thereof, but it is not limited thereto.

Subsequently, the method may include allowing the ligand bound to the particle to specifically bind to the surface marker of the target cell to form a particle-target cell complex.

Contacting the biological sample with the particle positions the particle in proximity to target cell. Subsequently, the ligand bound to the particle may specifically bind to the surface marker which is present on the surface of the target cell. For example, when an antibody specific for EpCAM and/or C-Met is used as the ligand, the ligand can specifically bind to EpCAM and/or C-Met on circulating tumor cells. Thus, the particle via the ligand binding to the surface marker may form a complex with the target cell. Due to formation of the complex, the overall density of the complex is altered compared to those of other cells in a biological sample, which have the same density as or a density similar to, that of the target cell.

Finally, the method may include separating the second cell having the density difference with the particle-target cell complex by density gradient centrifugation.

The complex in the biological sample may be separated from other components of the biological according to a density value by density gradient centrifugation, as well known to the art. In particular, the complex may be separated by isopycnic separation in the present step. During centrifugation, sedimentation of a material continues until the density of the ambient medium and the density of the material are identical and thus a layer is formed at the isopycnic point. Therefore, isopycnic separation is carried out with a range of gradient densities such that the density of particles in the sample fall within that range and irrespective of the gradient length. Sufficient centrifugation time should be given such that the various kinds of cells included in the biological sample, including the complex, may band to a separated layer at their isopycnic point. For isopycnic separation, various media known in the art may be use, at various concentrations, depending on the biological sample to be applied. For example, the medium may include Ficoll, Percoll, Nycodenz, and the like, but it is not limited thereto. Since the complex has a density difference from other cells in the biological sample, which have a density similar or identical to that of the unbound target cell, a layer of the complex, separate from layers of the other cells in the biological sample, may be formed. The layer of the gradient with the complex may then be extracted automatically or manually from the gradient to be used according to the purpose of the experimenters.

According to another aspect of the present invention, a method of separating a target cell in a biological sample includes contacting a particle to which is bound at least one ligand specific to a surface marker of a target cell with a biological sample including at least one of the target cell and a second type of cell; allowing the at least one ligand bound to the particle to specifically bind to the surface marker of the target cell to form a particle-target cell complex, wherein the particle-target cell complex has a density different from that of the second cell; and removing the rest portion which is not formed the particle-target cell complex by centrifugation.

According to an exemplary embodiment, the method may further include, after the removing, separating the second cell from the particle-target cell complex by filtration.

Since the step of contacting and allowing described above, the common descriptions are omitted in order to avoid undue redundancy leading to the complexity of this specification.

The method may include, after forming a particle-target cell complex, removing the rest portion which is not formed the particle-target cell complex by centrifugation.

The centrifugation may be accomplished by the any common method which used by one of ordinary skill in the art. The rest portion except the particle-target cell complex could be removed mainly by centrifugation. After this, the remaining portion including the particle-target cell complex may be applied to the filtration, if necessary, to separate the particle-target cell complex.

The filtration may be accomplished using filter, for example. The particle-target cell complex. The density and volume of the particle-target cell complex are greater than the cells not forming the complex. Thus, the pore size of the filter may be the one greater than the diameter of the cells and the one smaller than the diameter of the particle-target cell complex. For example, the pore size may be the range of about 3 μm to about 30 μm, about 5 μm to about 20 μm, or, about 8 μm to about 14 μm.

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description.

### Example 1

### Manufacture of a Particle to which an Antibody Specifically Binding to EpCAM is Bound

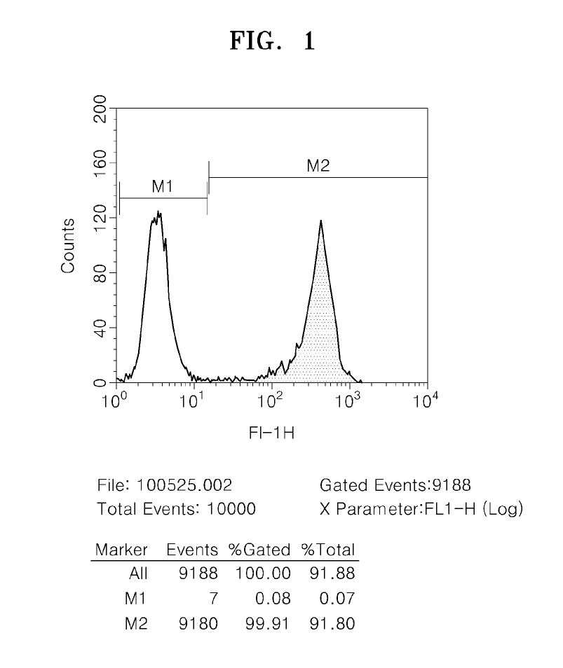

In a method of separating a target cell in a biological sample according to an exemplary embodiment, a breast cancer cell line MCF-7 (Korean Cell Line Bank) was used as a target cell to be separated. Accordingly, various kinds of commercially available antibodies were tested by flow cytometric analysis in order to select an antibody specifically binding to EpCAM in the target cell. As a result, a Human EpCAM/TROP1 Fluorescein monoclonal antibody MAb (Clone 158206), Mouse IgG2B (Cat. # FAB9601 F, R&D Systems, Inc.: hereinafter “anti-EPCAM MAb) was selected (FIG. 1). The anti-EPCAM antibody was allowed to bind to the particle using the following method.

Amine-modified polystyrene beads (Sigma-Aldrich) or melamine beads (Postnova) having a diameter of about 2 μm˜3 μm were washed three times with phosphate buffered saline (PBS). Polymaleic acid having a carboxylic group activated with 1-ethyl-3(3-dimethyl aminopropyl)carbodiimide/N-hydroxysuccinimide (EDC/NHS) was added to the beads and allowed to react with the beads at room temperature for about 1.5 hours while being stirred. Subsequently, the beads were washed three times with PBS buffer, again activated with EDC/NHS while being slowly stirred at room temperature for 20 minutes, followed by reaction with about 625 ug/ml of anti-EPCAM MAb for about 1.5 hours to obtain polystyrene particles or melamine particles to which the anti-EPCAM MAb was bound.

### Example 2

### Agglutination Experiment Performed with the Particle to which Anti-EpCAM Mab is Bound and a Cancer Cell

First, 20 μl of the polystyrene particles to which anti-EPCAM MAb is bound were added to a test tube. Then, 3 ml of blood including about 100 cells of the breast cancer cell line MCF-7 was added to the test tube and allowed react at room temperature for about 1 hour while being slowly stirred. The blood was from a normal patient, obtained in accordance with regulations of the Institutional Review Board at Yonsei University College of Medicine. Subsequently, particles showing fluorescence due to the fluorescein bound to the antibody were observed by using a fluorescent microscope (Olympus IX81). In addition, polystyrene beads without the antibody were used as a control in an experiment performed in the same manner.

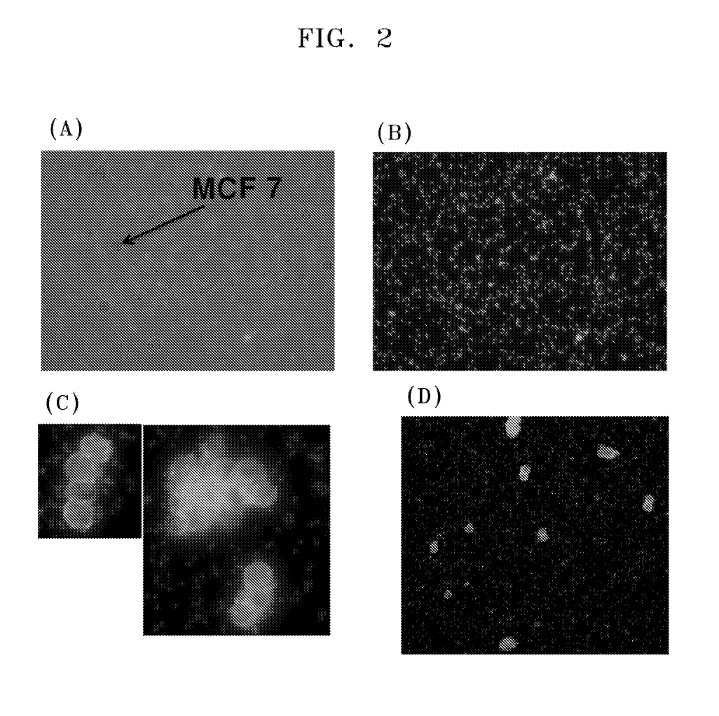

Results are shown in FIG. 2. Polystyrene beads without bound antibody were not bound to the breast cancer cells (FIG. 2 (A)) and did not show any non-specific binding (FIG. 2 (B)). In contrast, polystyrene beads with bound ant-EpCAM MAb were bound to the surface of the breast cancer cell (FIGS. 2 (C) and (D)), as shown by the degree of fluorescence observed.

### Example 3

### Separation Experiment Performed on Cancer Cells in Blood Using Density Gradient Centrifugation

Since white blood cells and circulating cancer cells are similar in terms of physical properties, it is known that they may separate in the same layer when density gradient centrifugation is performed. Accordingly, an experiment for separating only cancer cells in blood was performed in the present Example. The polystyrene particles with bound anti-EpCAM Mab were allowed to bind to cancer cells in the blood, producing a difference in density between the cancer cell-polystyrene particle complex and the white blood cells.

First, 4 ml of a normal patient's blood, obtained in accordance with regulations of the Institutional Review Board at Yonsei University College of Medicine, was added to a test tube and then spiked with 100 cells of the breast cancer cell line MCF-7. About 20 ul (4.5×10⁸ ea) of polystyrene particles with bound anti-EpCAM MAb were added to the test tube, and incubated for about 1 hour. Subsequently, about 3 ml of 100% Ficoll was injected into a 15 ml tube, to which the reaction was loaded, followed by centrifugation at 400×g conditions for about 20 minutes.

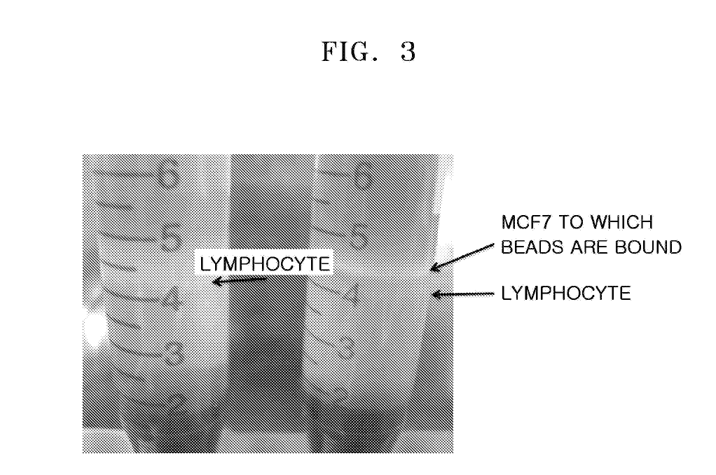

As shown in FIG. 3, the cancer cells bound to the polystyrene particles with the bound anti-EpCAM MAb formed a layer in a portion of the density gradient formed during centrifugation above the layer of the lymphocytes. The density of the polystyrene particles used in the experiment was about 1.05 g/cm³, which was a value smaller than that of lymphocytes (about 1.07 g/cm³). Even though the number of the cancer cells in the blood sample was small, the cancer cells were separated from the lymphocytes due to the density of the polystyrene particles to which the cancer cells were bound. Thus, even when only a small quantity of the target cell is present in a biological sample, the method of separating the target cell from other cells in the sample, according to an exemplary embodiment of the invention, permits effective separation of the target cell.

### Example 4

### Separation Experiment Performed on Cancer Cells in Blood by Centrifugation and Filtration

An experiment for separating only cancer cells in blood was performed in the present Example. The melamine particles with bound anti-EpCAM Mab were allowed to bind to cancer cells in the blood, separating the cancer cell-melamine particle complex from the white blood cells and the red blood cells by centrifugation and filtration.

First, 4 ml of a normal patient's blood, obtained in accordance with regulations of the Institutional Review Board at Yonsei University College of Medicine, was added to a test tube and then spiked with 100 cells of the breast cancer cell line MCF-7. About 100 ul (1.0×10⁵ ea) of melamine particles with bound anti-EpCAM MAb were added to the test tube, and incubated for about 1 hour. Subsequently, about 3 ml of Density gradient Ficoll Paque (Oslo) was injected into a 15 ml tube, to which the reaction was loaded, followed by centrifugation at 400×g conditions for about 10 minutes.

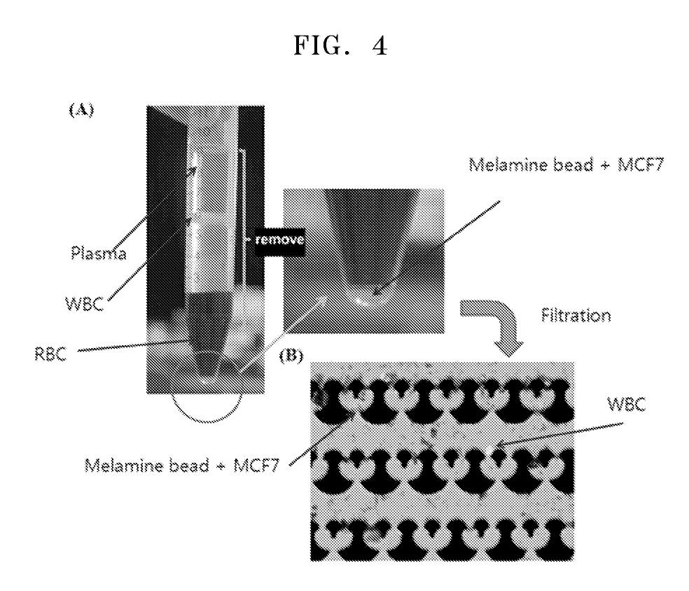

As shown in FIG. 4(A), the cells, such as the white blood cells or the red blood cells, which have lower density than the cancer cell-melamine particle complex were separated in the upper portion of the tube, whereas, the cancer cells bound to the melamine particles with the bound anti-EpCAM MAb were separated in the bottom end of the tube. The upper portion were removed, followed by the resultant were filtered using filter having 8˜14 μm of the pore size. After the filtration, the filter was examined using fluorescent microscope (Olympus). As shown in FIG. 4(B), it was identified that the cancer cell-melamine particle complex was easily separated by filtration because the complex was increased in size and density compared with other cells in the blood.

A target cell may be efficiently separated from a biological sample including at least one other type of cell which is similar in density to the target cell by the method of separating a target cell in a biological sample according to an exemplary embodiment disclosed herein.

The terminology used herein is for the purpose of describing particular embodiments only and is not intended to be limiting of the invention. The terms “a” and “an” do not denote a limitation of quantity, but rather denote the presence of at least one of the referenced item. The terms “comprising”, “having”, “including”, and “containing” are to be construed as open-ended terms (i.e. meaning “including, but not limited to”).

Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable.

All methods described herein can be performed in a suitable order unless otherwise indicated herein or otherwise clearly contradicted by context. No language in the specification should be construed as indicating any non-claimed element as essential to the practice of the invention as used herein.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A method of separating a target cell in a biological sample, the method comprising:
contacting a biological sample comprising a target cell and a second cell with a particle to which is bound a ligand specific to a surface marker of the target cell;
allowing the ligand bound to the particle to specifically bind to the surface marker of the target cell to form a particle-target cell complex,
wherein the particle-target cell complex has a density difference with the second cell; and
separating the second cell from the particle-target cell complex by density gradient centrifugation.

2. The method of claim 1, wherein the density difference of the particle-target cell complex from that of the second cell is in a range of about 0.005 g/cm³ to about 0.05 g/cm³.

3. The method of claim 1, wherein the target cell is selected from the group consisting of a circulating tumor cell, a cancer stem cell, an immunocyte, a fetal stem cell, a fetal cell, a cancer cell, and a tumor cell.

4. The method of claim 1, wherein the target cell is a cancer cell or a tumor cell and the cancer cell or tumor cell is from a cancer selected from the group consisting of bladder cancer, breast cancer, cervical cancer, cholangiocarcinoma cancer, colorectal cancer, endometrial cancer, esophageal cancer, gastric cancer, head and neck cancer, kidney cancer, liver cancer, lung cancer, nasopharyngeal cancer, ovarian cancer, pancreatic cancer, gallbladder cancer, prostate cancer, thyroid cancer, osteosarcoma, synovial sarcoma, rhabdomyosarcoma, synovial sarcoma, Kaposi's sarcoma, leiomyosarcoma, malignant fibrous histocytoma, fibrosarcoma, adult T-cell leukemia, lymphoma, multiple myeloma, glioblastoma/astrocytoma, melanoma, mesothelioma, and Wilms' tumor.

5. The method of claim 1, further comprising,
before the contacting, pre-treating the biological sample to reduce the amount of material other than the target cell and the second cellin the biological sample.

6. The method of claim 1, wherein the biological sample is selected from the group consisting of blood, marrow fluid, saliva, lacrimal fluid, urine, semen, mucous fluid, and any combination thereof.

7. The method of claim 1, wherein the surface marker is selected from the group consisting of estrogen receptor, progesterone receptor, synaptophysin, mucin 1 (MUC 1), Bcl-2, MIB1/Ki67, cyclin D1, cyclin E, p27, topoisomerase IIa, cyclooxygenase 2, ERK1/ERK2, phosphor-S6 ribosomal protein, CK5, CK8, CK17, vimentin, epithelial cell adhesion molecule (EpCAM), c-Met, cytokeratines, Her2, EGFR, p53, p63, E-cadherin, fragile histidine triad, protein tyrosine phosphatase, β-catenin, p16, c-kit, endothelin-1, endothelin receptor-α, endothelin receptor-β, chemokine (CXC motif) receptor 4, breast cancer resistance protein, ABCA3, MGMT, and any combination thereof.

8. The method of claim 1, wherein the particle has a density greater than or equal to about 1.0 g/cm³ and less than or equal to about 2.0 g/cm³.

9. The method of claim 1, wherein the particle is selected from the group consisting of a polystyrene particle, a polymethylmethacrylate particle, a latex particle, an ABS (tert-polymer of acrylonitrile, butadiene, and styrene) particle, a cyclic olefin copolymer particle, melamine particle, magnetic particle and a combination thereof.

10. The method of claim 1, wherein the particle has a diameter of about 10 nm to about 10 μm.

11. A method of separating a target cell in a biological sample, the method comprising:
contacting a biological sample comprising a target cell and a second cell with a particle to which is bound a ligand specific to a surface marker of the target cell;
allowing the ligand bound to the particle to specifically bind to the surface marker of the target cell to form a particle-target cell complex,
wherein the particle-target cell complex has a density difference with the second cell; and
removing the rest portion which is not formed the particle-target cell complex by centrifugation.

12. The method of claim 11, further comprising,
after the removing, separating the second cell from the particle-target cell complex by filtration.

13. The method of claim 11, wherein the target cell is selected from the group consisting of a circulating tumor cell, a cancer stem cell, an immunocyte, a fetal stem cell, a fetal cell, a cancer cell, and a tumor cell.

14. The method of claim 11, wherein the target cell is a cancer cell or a tumor cell and the cancer cell or tumor cell is from a cancer selected from the group consisting of bladder cancer, breast cancer, cervical cancer, cholangiocarcinoma cancer, colorectal cancer, endometrial cancer, esophageal cancer, gastric cancer, head and neck cancer, kidney cancer, liver cancer, lung cancer, nasopharyngeal cancer, ovarian cancer, pancreatic cancer, gallbladder cancer, prostate cancer, thyroid cancer, osteosarcoma, synovial sarcoma, rhabdomyosarcoma, synovial sarcoma, Kaposi's sarcoma, leiomyosarcoma, malignant fibrous histocytoma, fibrosarcoma, adult T-cell leukemia, lymphoma, multiple myeloma, glioblastoma/astrocytoma, melanoma, mesothelioma, and Wilms' tumor.

15. The method of claim 11, further comprising,
before the contacting, pre-treating the biological sample to reduce the amount of material other than the target cell and the second cellin the biological sample.

16. The method of claim 11, wherein the biological sample is selected from the group consisting of blood, marrow fluid, saliva, lacrimal fluid, urine, semen, mucous fluid, and any combination thereof.

17. The method of claim 11, wherein the surface marker is selected from the group consisting of estrogen receptor, progesterone receptor, synaptophysin, mucin 1 (MUC 1), Bcl-2, MIB1/Ki67, cyclin D1, cyclin E, p27, topoisomerase IIa, cyclooxygenase 2, ERK1/ERK2, phosphor-S6 ribosomal protein, CK5, CK8, CK17, vimentin, epithelial cell adhesion molecule (EpCAM), c-Met, cytokeratines, Her2, EGFR, p53, p63, E-cadherin, fragile histidine triad, protein tyrosine phosphatase, β-catenin, p16, c-kit, endothelin-1, endothelin receptor-α, endothelin receptor-β, chemokine (CXC motif) receptor 4, breast cancer resistance protein, ABCA3, MGMT, and any combination thereof.

18. The method of claim 11, wherein the particle has a density greater than or equal to about 1.0 g/cm³ and less than or equal to about 2.0 g/cm³.

19. The method of claim 11, wherein the particle is selected from the group consisting of a polystyrene particle, a polymethylmethacrylate particle, a latex particle, an ABS (tert-polymer of acrylonitrile, butadiene, and styrene) particle, a cyclic olefin copolymer particle, melamine particle, magnetic particle and a combination thereof.

20. The method of claim 11, wherein the particle has a diameter of about 10 nm to about 10 μm.
